(19) United States
(12) Patent Application Publication
(10) Pub. No.: US 2023/0112785 A1
(43) Pub. Date: Apr. 13, 2023

(54) ELECTRO-OPTICAL DEVICE

(71) Applicant: TDK CORPORATION, Tokyo (JP)

(72) Inventors: Kenji NAGASE, Hong Kong (CN); Hiroshi TAKE, Hong Kong (CN)

(73) Assignee: TDK CORPORATION, Tokyo (JP)

(21) Appl. No.: 17/914,140

(22) PCT Filed: Mar. 31, 2021
(86) PCT No.: PCT/JP2021/013931

§ 371 Date: Sep. 23, 2022

(30) Foreign Application Priority Data
Mar. 31, 2020 (CN) 202010241133.3

(51) Int. Cl. G02F 1/035; G02F 1/03; G02F 1/21

(52) U.S. Cl. CPC G02F 1/035; G02F 1/0316; G02F 1/212; G02F 2201/07

(57) ABSTRACT

An electro-optical device, including: a substrate; an optical waveguide film formed of electro-optical material provided in a predetermined region on the substrate; a buffer layer provided adjacent to the optical waveguide film; and an electrode for applying an electric field to the optical waveguide film, and a non-light-transmission optical waveguide film is provided outside the predetermined region. According to the electro-optical device of the present disclosure, the propagation loss of light can be suppressed.

### TECHNICAL FIELD

The present invention relates to an electro-optical device used in the fields of optical communication and optical instrumentation.

### BACKGROUND ART

Communication traffic has been remarkably increased with widespread Internet use, and optical fiber communication is becoming significantly important. The optical fiber communication is a technology that converts an electric signal into an optical signal and transmits the optical signal through an optical fiber and has wide bandwidth, low loss, and resistance to noise.

As a method for converting an electric signal into an optical signal, there are known a direct modulation system using a semiconductor laser and an external modulation method using an optical modulator. The direct modulation does not require the optical modulator and is thus low in cost, but has a limitation in terms of high-speed modulation and, thus, the external modulation method is used for high-speed and long-distance applications.

Patent Document 1 discloses a Mach-Zehnder optical modulator using a lithium niobate film. The optical modulator using the lithium niobate film (LN film) achieves significant reduction in size and driving voltage as compared with an optical modulator using the lithium niobate single-crystal substrate. FIG. 5 shows a cross-sectional structure of a conventional optical modulator 400 described in Patent Document 1. A pair of optical waveguides 22a and 22b of a lithium niobate film are formed on a sapphire substrate 21, and a signal electrode 24a and a ground electrode 24b are disposed above the optical waveguides 22a and 22b, respectively, through a buffer layer 23. The optical modulator 400 is of a so-called single drive type having one signal electrode 24a, and the signal electrode 24a and ground electrode 24b have a symmetrical structure, so that electric fields to be applied to the optical waveguides 22a and 22b are the same in magnitude and opposite in polarity.

In the optical waveguide using the LN film, the locking of the light is very important to reduce the driving voltage. Therefore, attention must be paid to the quality of the LN film and the microcracks in the LN film.

For example, since silicon oxide with a low refractive index is formed as a buffer layer adjacent to the LN film as an optical waveguide, the influence of stress caused by the difference between the thermal expansion coefficient of the LN film and the thermal expansion coefficient of silicon oxide may cause cracks in the optical waveguide film, thereby causing loss of light transmission.

### CITATION LIST

### Patent Literature

Patent Document

Patent Document 1: JP 2006-195383A

### SUMMARY OF INVENTION

The present invention has been completed in view of the above-mentioned problems, and its object is to provide an electro-optical device with a small light propagation loss, comprising: a substrate; an optical waveguide film formed of lithium niobate or tantalum niobate provided in a predetermined region on the substrate; a buffer layer provided adjacent to the optical waveguide film; and an electrode for applying an electric field to the optical waveguide film, and a non-light-transmission optical waveguide film is provided outside the predetermined region. According to the electro-optical device of the present invention, by providing a non-light-transmission optical waveguide film, the stress applied to the optical waveguide film from the buffer layer can be reduced, cracks can be suppressed in the optical waveguide film, and the optical transmission loss can be reduced.

In addition, in the electro-optical device of the present invention, it is preferable that the optical waveguide film has a linear section, and the non-light-transmission optical waveguide film is provided in the vicinity of the linear section. As a result, the occurrence of cracks in the optical waveguide film is further suppressed, thereby reducing optical transmission loss.

In addition, in the electro-optical device of the present invention, it is preferable that a plurality of non-light-transmission optical waveguide films are provided. Thus, the non-light-transmission optical waveguide film is appropriately provided according to the installation position of the optical waveguide film, and the occurrence of cracks in the optical waveguide film can be further suppressed, thereby reducing optical transmission loss.

In addition, in the electro-optical device of the present invention, it is preferable that the non-light-transmission optical waveguide film is arranged along the linear section. As a result, the occurrence of cracks in the optical waveguide film is further suppressed, thereby reducing optical transmission loss.

In addition, in the electro-optical device of the present invention, it is preferable that the thickness of the optical waveguide film and the non-light-transmission optical waveguide film are approximately the same. As a result, the occurrence of cracks in the optical waveguide film is further suppressed, thereby reducing optical transmission loss.

In addition, in the electro-optical device of the present invention, it is preferable that the optical waveguide film is interposed between the non-light-transmission optical waveguide films on a cross section perpendicular to the propagation direction of light. As a result, the occurrence of cracks in the optical waveguide film is further suppressed, thereby reducing optical transmission loss.

In addition, in the electro-optical device of the present invention, it is preferable that the non-light-transmission optical waveguide film provided on the substrate is surrounded by the buffer layer on a cross section perpendicular to the propagation direction of light. As a result, the structure of the non-light-transmission optical waveguide film and its surrounding buffer layer can be made consistent with the structure of the optical waveguide film and its surrounding buffer layer, and the stress applied to the optical waveguide film from the buffer layer is further reduced, thereby suppressing the occurrence of cracks on the optical waveguide film, and reducing optical transmission loss.

In addition, in the electro-optical device of the present invention, it is preferable that the optical waveguide film has a first optical waveguide film and a second optical waveguide film adjacent to each other, the non-light-transmission optical waveguide film is interposed at least between the first optical waveguide film and the second optical waveguide film. As a result, the stress applied to the optical waveguide film from the buffer layer can be further reduced, the occurrence of cracks on the optical waveguide film can be suppressed, and the optical transmission loss can be reduced.

In addition, in the electro-optical device of the present invention, it is preferable that the first optical waveguide film and the second optical waveguide film are Mach-Zehnder optical waveguides. As a result, a high-speed electro-optical device can be realized.

In addition, in the electro-optical device of the present invention, it is preferable that the non-light-transmission optical waveguide film is formed at least between the optical waveguide film and the end portion of the substrate. Thereby, it is possible to suppress the stress from the end portion of the substrate from being applied to the optical waveguide film, to suppress the occurrence of cracks in the optical waveguide film, and to reduce the optical transmission loss.

### Advantageous Effects of the Invention

According to the electro-optical device of the present invention, the stress applied to the optical waveguide film from the buffer layer can be reduced, the generation of cracks in the optical waveguide film can be suppressed, and the optical transmission loss can be reduced.

### BRIEF DESCRIPTION OF DRAWINGS

FIGS. 1(a) and 1(b) are plan views of the optical modulator 100 according to the first embodiment of the present invention, in which FIG. 1(a) illustrates only an optical waveguide, and FIG. 1(b) illustrates the entire configuration of the optical modulator 100 including traveling-wave electrodes.

FIG. 2 is a schematic cross-sectional view of the optical modulator 100 taken along line A-A′ of FIG. 1(b).

FIG. 3(a) is a plan view illustrating only the optical waveguide of the optical modulator 200 according to the second embodiment of the present invention. FIG. 3(b) is a schematic cross-sectional view of the optical modulator 200 taken along line A-A′ of FIG. 3(a).

FIG. 4(a) is a plan view illustrating only the optical waveguide of the optical modulator 300 according to the third embodiment of the present invention. FIG. 4(b) is a schematic cross-sectional view of the optical modulator 300 taken along line A-A′ of FIG. 4(a).

FIG. 5 is a cross-sectional structure of conventional optical modulator 400.

### DESCRIPTION OF EMBODIMENTS

Preferred embodiments of the present invention will be described in detail with reference to the accompanying drawings.

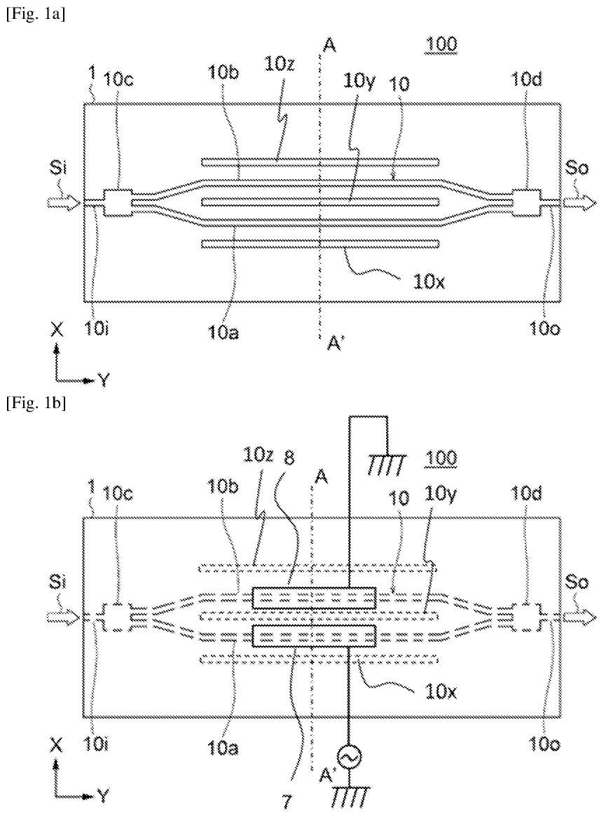

FIGS. 1(a) and 1(b) are plan views of an optical modulator (electro-optical device) 100 according to the first embodiment of the present invention, FIG. 1(a) illustrates only the optical waveguide, and FIG. 1(b) shows the entire of the optical modulator 100 including traveling wave electrodes.

As illustrated in FIG. 1(a) and FIG. 1(b), the optical modulator 100 includes a Mach-Zehnder optical waveguide 10 formed on a substrate 1 and having first and second optical waveguides 10a, 10b provided in parallel to each other; a first electrode 7 provided along the first optical waveguide 10a; and a second electrode 8 provided along the second optical waveguide 10b.

The Mach-Zehnder optical waveguide 10 is, for example, an optical waveguide having a structure of a Mach-Zehnder interferometer. The Mach-Zehnder optical waveguide 10 has the first and second optical waveguides 10a, 10b which are branched from a single input optical waveguide 10i at a demultiplexing section 10c, and the first and second optical waveguides 10a, 10b are combined into a single output optical waveguide 10o at a multiplexing section 10d. An input light Si is demultiplexed by the demultiplexing section 10c and travels through the first and second optical waveguides 10a, 10b, respectively, and then multiplexed at the multiplexing section 10d, the multiplexed light is output from the output optical waveguide 10 as modulated light So.

The first electrode 7 covers the first optical waveguide 10a in a plan view, and the second electrode 8 also covers the second optical waveguide 10b in a plan view. That is, the first electrode 7 is formed on the first optical waveguide 10a via a buffer layer (to be described later), and the second electrode 8 is also formed on the second optical waveguide 10b via a buffer layer. The first electrode 7 is connected to, for example, an AC signal, and can be referred to as a signal electrode. The second electrode is grounded, for example, and may be referred to as a “ground” electrode.

The electric signal (modulated signal) is input to the first electrode 7. The first and second optical waveguides 10a and 10b are made of a material, such as lithium niobate having electro-optical effect, so that the refractive indices of the first and second optical waveguides 10a and 10b are changed with +Δn and −Δn by an electric field applied to the first and second optical waveguides 10a and 10b, with the result that a phase difference between the pair of optical waveguides changes. A signal light modulated by the change in the phase difference is output from the output optical waveguide 10o.

In addition, in regions other than the regions (predetermined regions) where the first and second optical waveguides 10a and 10b are provided, non-light-transmission optical waveguides 10x, 10y, and 10z formed on the substrate 1 are also provided. Here, the non-light-transmission optical waveguides 10x, 10y, and 10z may be optical waveguides that do not transmit light in actual work. That is, the input light Si does not propagate in the non-light-transmission optical waveguides 10x, 10y, 10z, so that the non-light-transmission optical waveguides 10x, 10y, 10z do not need to be provided with electrodes for applying electric fields to them. In FIG. 1(a), the non-light-transmission optical waveguides 10x, 10y, and 10z are, e.g., provided along the linear portions of the first and second optical waveguides 10a, 10b, and a plurality of (three) optical waveguides are provided. Specifically, the non-light-transmission optical waveguide 10y is interposed between the first and second optical waveguides 10a, 10b. The non-light-transmission optical waveguides 10x and 10y are provided with the first optical waveguide 10a interposed therebetween. The non-light-transmission optical waveguides 10y and 10z are provided with the second optical waveguide 10b interposed therebetween. The non-light-transmission optical waveguides 10x, 10y, and 10z may all extend along the extending direction of the first and second optical waveguides 10a, 10b.

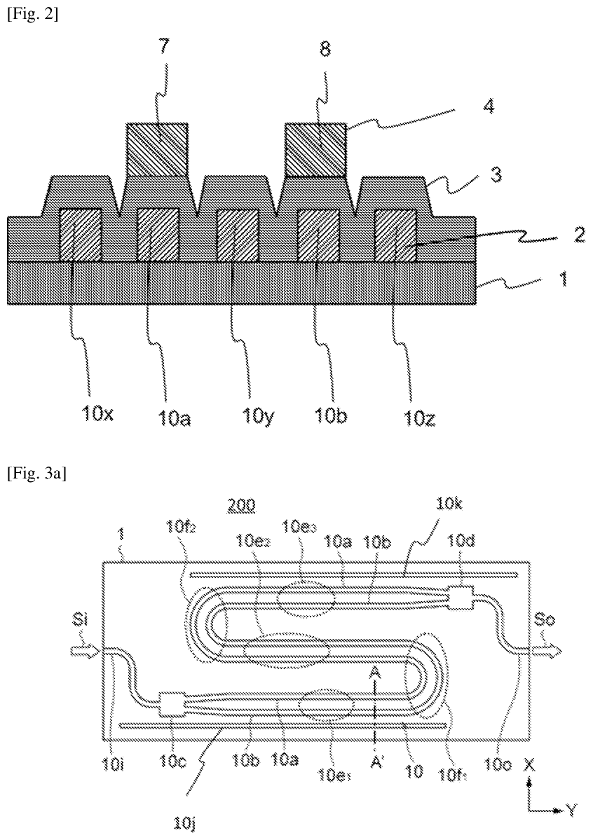

FIG. 2 is a schematic cross-sectional view of the optical modulator 100 taken along line A-A′ of FIG. 1(b).

As illustrated in FIG. 2, the optical modulator 100 of the present embodiment has a multilayer structure including a substrate 1, a waveguide layer 2, a buffer layer 3, and an electrode layer 4 which are laminated in this order. The substrate 1 is, e.g., a sapphire substrate, and a waveguide layer 2 made of a lithium niobate film or tantalum niobate is formed on the surface of the substrate 1. The waveguide layer 2 has the first and second optical waveguides 10a, 10b. The width of the first and second optical waveguides 10a, 10b may be, e.g., 1 μm.

The buffer layer 3 is formed on at least the upper surfaces of the first and second optical waveguides 10a and 10b of the waveguide layer 2 so as to prevent light propagating through the first and second optical waveguides 10a, 10b from being absorbed by the first electrode 7 or the second electrode 8. Therefore, the buffer layer 3 only needs to function as an intermediate layer between the optical waveguide and the signal electrode, and the material of the buffer layer can be widely selected as long as it is a non-metal. For example, the buffer layer may use a ceramic layer made of insulating materials such as metal oxides, metal nitrides, and metal carbides. The material of the buffer layer may be a crystalline material or an amorphous material. The buffer layer 3 is preferably formed of a material having a lower refractive index than the waveguide layer 2, such as Al₂O₃, SiO₂, LaAlO₃, LaYO₃, ZnO, HfO₂, MgO, Y₂O₃, and the like. The thickness of the buffer layer formed on the optical waveguide may be about 0.2 μm to 1.2 μm. In the present embodiment, the buffer layer 3 not only covers the upper surfaces of the first and second optical waveguides 10a, 10b, but is also buried between the first and second optical waveguides 10a, 10b. That is, the buffer layer 3 is also formed in a region that does not overlap with the first and second optical waveguides 10a and 10b in a plan view. The buffer layer 3 covers the substrate 1 on which the waveguide layer 2 is not formed, and the side surfaces of the first and second optical waveguides 10a, 10b are also covered with the buffer layer 3, so that scattering loss due to the roughness of the side surfaces of the first and second optical waveguides 10a and 10b can be prevented.

The electrode layer 4 is provided with the first electrode 7 and second electrode 8. The first electrode 7 is provided overlapping the waveguide layer 2 corresponding to the first optical waveguide 10a so as to modulate light traveling inside the first optical waveguide 10a and opposed to the first optical waveguide 10a through the buffer layer 3. The second electrode 8 is provided overlapping the waveguide layer 2 corresponding to the second optical waveguide 10b so as to modulate light traveling inside the second optical waveguide 10b and opposed to the second optical waveguide 10b through the buffer layer 3.

As illustrated in FIG. 2, the non-light-transmission optical waveguide 10x, the first optical waveguide 10a, the non-light-transmission optical waveguide 10y, the second optical waveguide 10b, and the non-light-transmission optical waveguide 10z are arranged in sequence perpendicular to the propagation direction of light. The first electrode 7 and second electrode 8 are provided on the first optical waveguide 10a and the second optical waveguide 10b through the buffer layer 3. The non-light-transmission optical waveguide 10x, the non-light-transmission optical waveguide 10y, and the non-light-transmission optical waveguide 10z are provided with a buffer layer 3, but no electrodes are provided. This is because the non-light-transmission optical waveguides 10x, 10y, and 10z only function as dummy optical waveguides in actual work, and do not actually transmit optical signals. As illustrated in FIG. 2, the non-light-transmission optical waveguides 10x, 10y, and 10z provided on the substrate 1 are surrounded by the buffer layer 3, and the film thicknesses of the first and second optical waveguides 10a, 10b and the non-light-transmission optical waveguides 10x, 10y, and 10z are approximately the same. Thus, the structure of the non-light-transmission optical waveguides 10x, 10y, 10z and the buffer layer 3 thereon is substantially the same as that of the first and second optical waveguides 10a, 10b and the buffer layer 3 thereon, which can reduce the stress applied to the optical waveguides 10a, 10b from the buffer layer 3, and suppress the occurrence of cracks in the optical waveguides 10a, 10b, thereby improving reliability and reducing optical transmission loss.

Although the waveguide layer 2 is not particularly limited as long as it is an electro-optical material, it is preferably made of lithium niobate or tantalum niobate. This is because lithium niobate or tantalum niobate has a large electro-optical constant and is thus suitable as the constituent material of an optical device such as an optical modulator.

Although the substrate 1 is not particularly limited in material as long as it has a lower refractive index than the lithium niobate film or tantalum niobate film, the substrate 1 is preferably a substrate on which the lithium niobate film or tantalum niobate film can be formed as an epitaxial film. Specifically, the substrate 1 is preferably a sapphire single-crystal substrate or a silicon single-crystal substrate. The crystal orientation of the single-crystal substrate is not particularly limited.

The lithium niobate film or the tantalum niobate film preferably has a thickness of equal to or smaller than 2 μm. This is because a high-quality lithium niobate film having a thickness larger than 2 μm is difficult to form. On the other hand, the optical waveguide film having an excessively small thickness cannot completely confine light, allowing light to leak to the substrate or the buffer layer and thus to be guided therethrough. Even if an electric field is applied to the optical waveguide film, it is possible to reduce the change in the effective refractive index of the optical waveguides (1a, 1b). Therefore, the optical waveguide film preferably has a thickness that is at least approximately one-tenth of the wavelength of light to be used.

The inventor of the present invention conducted the following experiment in order to verify the relationship between the non-light-transmission optical waveguide film and the propagation loss of light. Among them, the sample 1 is an electro-optical device with a non-light-transmission optical waveguide film. Sample 2 is an electro-optical device with the same structure as sample 1 except that no non-light-transmission optical waveguide film is provided.

| | Whether there are microcracks on | |
|---|---|---|
| | the optical waveguide film | Light propagation loss |
| Sample 1 | no | 12 dB |
| Sample 2 | yes | No light |

It can be seen from the table that when a non-light-transmission optical waveguide film is provided, there are no micro-cracks on the optical waveguide film, and the propagation loss of light is small. When the non-light-transmission optical waveguide film (dummy optical waveguide film) is not provided, micro-cracks appear on the optical waveguide film, and the problem of “non-light guiding” occurs. Therefore, according to the optical modulator 100 of the first embodiment, the stress applied to the optical waveguides 10a, 10b from the buffer layer 3 can be reduced, and the occurrence of cracks in the optical waveguides 10a, 10b can be suppressed, thereby improving reliability and reducing optical transmission loss.

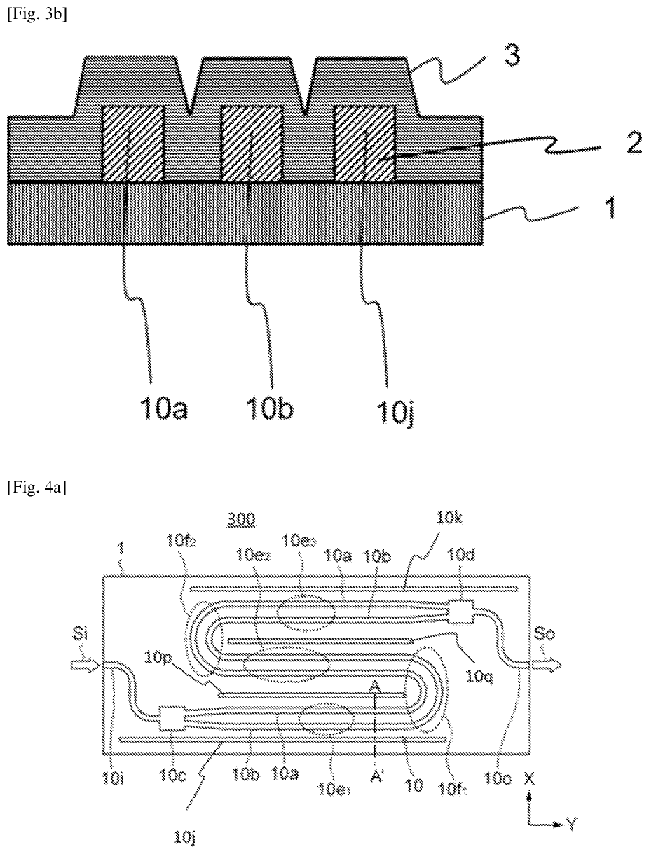

FIG. 3(a) is a plan view illustrating only the optical waveguide of the optical modulator 200 according to the second embodiment of the present invention. FIG. 3(b) is a schematic cross-sectional view of the optical modulator 200 taken along line A-A′ of FIG. 3(a). As illustrated in FIGS. 3(a) and 3(b), the optical modulator 200 according to the second embodiment is characterized in that the Mach-Zehnder optical waveguide 10 is constructed by a combination of linear sections and curved sections. More specifically, the Mach-Zehnder optical waveguide 10 has first to third linear sections 10e₁, 10e₂, 10e₃ arranged parallel to one another, a first curved section 10f₁ connecting the first and second linear sections 10e₁ and 10e₂, and a second curved portion 10f₂ connecting the second and third linear sections 10e₂ and 10e₃.

In the optical modulator 200 according to the present embodiment, the cross-sectional structures of the respective linear sections 10e₁ of the Mach-Zehnder optical waveguide 10 taken along line A-A′ in FIG. 3(a) is illustrated in FIG. 3(b). Further, the first electrode 7 covers the first optical waveguide 10a at the first to third linear sections 10e₁, 10e₂, and 10e₃ through the buffer layer 3. In addition, the second electrode 8 covers the second optical waveguide 10b at the first to third linear sections 10e₁, 10e₂, and 10e₃ through the buffer layer 3. The first electrode 7 and the second electrode 8 each preferably cover all the first to third linear sections 10e₁, 10e₂, and 10e₃, but may each cover only, e.g., the first linear section 10e₁.

In the present embodiment, the input light Si is input to one end of the first linear section 10e₁ and travels from the one end of the first linear section 10e₁ toward the other end thereof, makes a U-turn at the first curved section 10f₁, travels from one end of the second linear section 10e₂ toward the other end thereof in the direction opposite to that in the first linear section 10e₁, makes a U-turn at the second curved section 10f₂, and travels from one end of the third linear section 10e₃ toward the other end thereof in the direction same as that in the first linear section 10e₁.

The optical modulator has a problem of a long element length. However, by folding the optical waveguide as illustrated, the element length can be significantly reduced and a remarkable effect can be obtained. In particular, the optical waveguide formed of the lithium niobate film is featured in that it has small loss even when the curvature radius thereof is reduced to, for example, about 50 μm, and is thus suitable for the present embodiment.

In addition, in the present embodiment, non-light-transmission optical waveguides 10j, 10k formed on the substrate 1 are also provided in regions other than the regions (predetermined regions) where the first and second optical waveguides 10a, 10b are provided. The non-light-transmission optical waveguide 10j is formed between the first linear section 10e₁ and the end portion of the substrate 1 (as shown in FIG. 3(b)). Preferably, the non-light-transmission optical waveguide 10j is formed along the first linear section 10e₁. In addition, the non-light-transmission optical waveguide 10j illustrated in FIG. 3(a) is formed continuously, but it is not limited to this, and it may be formed intermittently. For example, the non-light-transmission optical waveguide 10j may be formed in an island-shaped pattern, and the individual island-shaped patterns may be arranged along a straight line. Similarly, the non-light-transmission optical waveguide 10k is preferably formed between the third linear section 10e₃ and the end portion of the substrate 1. Preferably, the non-light-transmission optical waveguide 10k is arranged along the third linear section 10e₃. In addition, the non-light-transmission optical waveguide 10k illustrated in FIG. 3(a) is formed continuously, but it is not limited to this, and may be formed intermittently. For example, the non-light-transmission optical waveguide 10k may be formed as an island-shaped pattern, and the individual island-shaped patterns may be arranged along a straight line. The cross-sectional structure of the non-light-transmission optical waveguides 10j, 10k may be the same structure as the non-light-transmission optical waveguides 10x, 10y, and 10z illustrated in FIG. 2. According to the optical modulator 200 of the second embodiment, it is also possible to obtain the same effects as the optical modulator 100 of the first embodiment, and it is possible to reduce the stress applied to the optical waveguides 10a, 10b (the first linear section 10e₁ and the third linear section 10e₃) from the buffer layer 3, and suppress the occurrence of cracks in the optical waveguides 10a, 10b, thereby improving reliability and reducing optical transmission loss. In addition, since the end portion of the substrate is particularly susceptible to external stress, by placing non-light-transmission optical waveguides 10j, 10k near the end portion of the substrate, it is possible to further suppress the occurrence of cracks in the optical waveguides 10a, 10b, thereby improving reliability and reducing optical transmission loss.

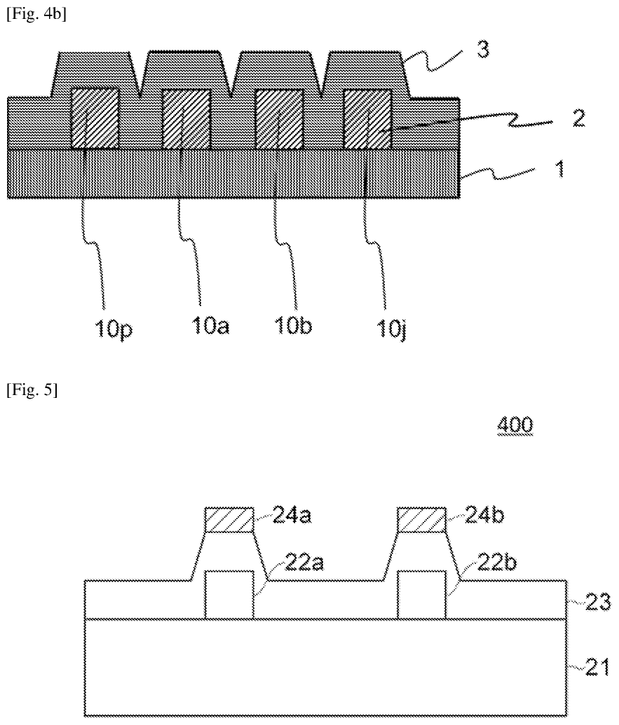

FIG. 4(a) is a plan view illustrating only the optical waveguide of the optical modulator 300 according to the third embodiment of the present invention. FIG. 4(b) is a schematic cross-sectional view of the optical modulator 300 taken along line A-A′ of FIG. 4(a). The optical modulator 300 of the third embodiment differs from the optical modulator 200 of the second embodiment in that it further includes a non-light-transmission optical waveguide 10p provided between the first linear section 10e₁ and the second linear section 10e₂, and a non-light-transmission optical waveguide 10q provided between the second linear section 10e₂ and the third linear section 10e₃. Specifically, the non-light-transmission optical waveguide 10j and the non-light-transmission optical waveguide 10p are arranged so as to face each other with the first linear section 10e₁ interposed therebetween. The non-light-transmission optical waveguide 10p and the non-light-transmission optical waveguide 10q are arranged so as to face each other with the second linear section 10e₂ interposed therebetween. The non-light-transmission optical waveguide 10q and the non-light-transmission optical waveguide 10k are arranged so as to face each other with the third linear portion 10e₃ interposed therebetween. The cross-sectional structure of the non-light-transmission optical waveguides 10j, 10p are illustrated in FIG. 4(b). According to the optical modulator 300 of the third embodiment, it is also possible to obtain the same effects as the optical modulator 100 of the first embodiment, and it is possible to reduce the stress applied to the optical waveguides 10a, 10b (the first to third linear sections 10e₁, 10e₂, 10e₃) from the buffer layer 3, and suppress the occurrence of cracks in the optical waveguides 10a, 10b (the first to third linear sections 10e₁, 10e₂, 10e₃), thereby improving reliability and reducing optical transmission loss. Although the present invention has been specifically described above in conjunction with the drawings and embodiments, it can be understood that the above description does not limit the present invention in any form. For example, in the above description, the first electrode is used as a signal electrode and the second electrode is used as a ground electrode. However, it is not limited to this, and the first and second electrodes may be any electrodes that apply an electric field to the optical waveguide. In addition, in the above description, the non-light-transmission optical waveguide is provided in the vicinity of the linear section of the optical waveguide, but it is not limited to this, and the non-light-transmission optical waveguide may also be provided in the bent section or the curved portion of the optical waveguide.

Those skilled in the art can make modifications and changes to the present invention as needed without departing from the essential spirit and scope of the present invention, and these modifications and changes fall within the scope of the present invention.

### REFERENCE SIGNS LIST

1 substrate
2 waveguide layer
3 buffer layer
4 electrode layer
7 first electrode
8 second electrode
10 Mach-Zehnder optical waveguide
10a first optical waveguide
10b second optical waveguide
10c demultiplexing section
10d multiplexing section
10i input optical waveguide
10o output optical waveguide
10e₁ first linear section of the Mach-Zehnder optical waveguide
10e₂ second linear section of the Mach-Zehnder optical waveguide
10e₃ third linear section of the Mach-Zehnder optical waveguide
10f₁ first curved section of the Mach-Zehnder optical waveguide
10f₂ second curved section of the Mach-Zehnder optical waveguide
10i input optical waveguide
10o output optical waveguide

1. An electro-optical device comprising:
a substrate;
an optical waveguide film formed of electro-optical material provided in a predetermined region on the substrate;
a buffer layer provided adjacent to the optical waveguide film; and
an electrode configured to apply an electric field to the optical waveguide film,
a non-light-transmission optical waveguide film is provided outside the predetermined region.

2. The electro-optical device according to claim 1, wherein the optical waveguide film has a linear section, and the non-light-transmission optical waveguide film is provided in the vicinity of the linear section.

3. The electro-optical device according to claim 1, wherein a plurality of the non-light-transmission optical waveguide films are provided.

4. The electro-optical device according to claim 2, wherein the non-light-transmission optical waveguide film is arranged along the linear section.

5. The electro-optical device according to claim 1, wherein the thickness of the optical waveguide film and the non-light-transmission optical waveguide film are approximately the same.

6. The electro-optical device according to claim 1, wherein the optical waveguide film is interposed between the non-light-transmission optical waveguide films on a cross section perpendicular to the propagation direction of light.

7. The electro-optical device according to claim 1, wherein the non-light-transmission optical waveguide film provided on the substrate is surrounded by the buffer layer on a cross section perpendicular to the propagation direction of light.

8. The electro-optical device according to claim 1 wherein the optical waveguide film has a first optical waveguide film and a second optical waveguide film adjacent to each other, the non-light-transmission optical waveguide film is interposed at least between the first optical waveguide film and the second optical waveguide film.

9. The electro-optical device according to claim 8, wherein the first optical waveguide film and the second optical waveguide film are Mach-Zehnder optical waveguides.

10. The electro-optical device according to claim 1, wherein the non-light-transmission optical waveguide film is formed at least between the optical waveguide film and an end portion of the substrate.
